(19) United States
(12) Patent Application Publication
(10) Pub. No.: US 2026/0135447 A1
(43) Pub. Date: May 14, 2026

(54) SYSTEM AND METHOD FOR MANUFACTURING HALBACH ARRAY ROTOR

(71) Applicants: Hyundai Motor Company, Seoul (KR); Kia Corporation, Seoul (KR)

(72) Inventor: Seung Min Choi, Hwaseong-si (KR)

(21) Appl. No.: 19/224,305

(22) Filed: May 30, 2025

(30) Foreign Application Priority Data
Nov. 14, 2024 (KR) 10-2024-0162437

(51) Int. Cl. H02K 15/035; H02K 1/2783; H02K 15/038; H02K 15/90

(52) U.S. Cl. CPC H02K 15/035; H02K 1/2783; H02K 15/038; H02K 15/90; H02K 2215/00

(57) ABSTRACT

Disclosed are a system and method for manufacturing a Halbach array rotor.

A system for manufacturing a Halbach array rotor according to an embodiment of the present disclosure includes a magnet pre-magnetization device configured to seat non-magnetized magnets on holders radially disposed on an index, pre-magnetize the individual magnets by using automation devices installed for respective rotation sections in one side rotation direction, and then load the magnets to a hub, a clamping jig device configured to couple the hub to a circular arrangement jig and fix the individual magnets loaded onto an outer peripheral surface of the hub by using corresponding magnet clamping units, and a controller configured to magnetize the non-magnetized magnets in accordance with orientations by collectively controlling the magnet pre-magnetization device and the clamping jig device and then assemble the magnetized magnets on the hub in accordance with a magnetization direction of a Halbach array.

### CROSS-REFERENCE TO RELATED APPLICATIONS

This application claims priority to and the benefit of Korean Patent Application No. 10-2024-0162437 filed with the Korean Intellectual Property Office on Nov. 14, 2024, the entire contents of which are incorporated herein by reference.

### TECHNICAL FIELD

The present disclosure relates to a system and method for manufacturing a Halbach array rotor, and more particularly, to a system and method for manufacturing a Halbach array rotor, the system and method being capable of automating a process of assembling a surface permanent magnet (SPM) type Halbach array magnet.

### BACKGROUND

In general, a motor (actuator), which generates mechanical power, uses a surface permanent magnet (SPM) type rotor.

For example, a drive motor of an armature (EVx) includes a stator configured to generate a rotational magnetic field by receiving electrical energy from a battery, and a rotor configured to be rotated by the rotational magnetic field generated by the stator.

The rotor receives electric power and converts the rotational magnetic field generated by the stator into driving energy. To this end, the rotor has a structure in which a plurality of magnets (magnetic substances) is arranged around a cylindrical rotor hub (rotary body). In this case, the plurality of magnets may be assembled in the form of a circular Halbach array to amplify a magnetic field in a direction toward the stator. That is, the Halbach array has an advantage capable of maximizing (enhancing) the magnetic field (magnetic flux) of the magnet in a desired outward/inward direction. However, in terms of the process of manufacturing the Halbach array magnet, it is difficult to assemble a pre-magnetized magnet to the rotary body because of a repulsive force that allows the magnets to push each other.

For example, the methods of assembling the Halbach array in the related art include a post-magnetization permanent magnet assembling method and a pre-magnetization permanent magnet assembling method.

The post-magnetization permanent magnet assembling method is easy to manufacture (assemble) by using a non-magnetized magnet, but the post-magnetization permanent magnet assembling method has a fatal disadvantage in that magnetic saturation cannot be achieved, and performance deteriorates. For example, the Halbach array is characterized in that a magnet is oriented in a tangential direction to a rotary shaft. However, because the tangential direction is perpendicular to a direction in which magnetic flux is applied by an external electromagnet (yoke), there is a problem in that 100% saturation cannot be achieved.

The pre-magnetization permanent magnet assembling method has a problem in that it is difficult to implement the automation because of a repulsive force between the magnets during a process of assembling the magnets, and the magnets need to be manually bonded to the hub/shaft one by one. In particular, it is very difficult to implement the automation in case that the magnetized magnets need to be assembled while a predetermined gap between the magnetized magnets is maintained. In addition, a separate bonding material for fixing the magnet needs to be used before using a covering made of carbon fiber reinforced plastic (CFRP) and the like. Further, because the individual pre-magnetized magnets need to be magnetized one by one, unit manufacturing price may be increased.

The above information disclosed in this Background section is only for enhancement of understanding of the background of the present disclosure and therefore it may contain information that does not form the prior art that is already known to a person of ordinary skill in the art.

### SUMMARY

The present disclosure attempts to provide a system and method for manufacturing a Halbach array rotor, the system and method being capable of automating a process of assembling a Halbach array of magnets by collectively using a magnet pre-magnetization device configured to pre-magnetize separate non-magnetized magnets and a clamping jig device configured to separately fix magnetized magnets to a hub.

According to one aspect of the present disclosure, a system for manufacturing a Halbach array rotor includes: a magnet pre-magnetization device configured to seat non-magnetized magnets on holders radially disposed on an index, pre-magnetize the individual magnets by means of automation devices installed for respective rotation sections in one side rotation direction, and then load the magnets to a hub; a clamping jig device configured to couple the hub to a circular arrangement jig and fix the individual magnets loaded onto an outer peripheral surface of the hub by means of corresponding magnet clamping units; and a controller configured to magnetize the non-magnetized magnets in accordance with orientations by collectively controlling the magnet pre-magnetization device and the clamping jig device and then assemble the magnetized magnets on the hub in accordance with a magnetization direction of a Halbach array.

In addition, the system may further include: a base on which the arrangement jig, which rotates about a second axis C2 orthogonal to a first axis C1 about which the index rotates, is installed based on a loading direction of the magnet.

In addition, the index and the arrangement jig may rotate by preset one pitch 1P to perform pre-magnetization and assembling process corresponding to the individual magnets.

In addition, a rotation angle of one pitch P1 of the index may be determined depending on the number of holders disposed radially, and a rotation angle of one pitch P1 of the arrangement jig may be determined depending on the total number of magnets assembled to the hub.

In addition, the holder may have a structure in which two panels, which define a seating groove inside a housing having a “ [symbol] ”-shaped cross-section, are movably coupled by springs and hinges and catching portions are formed inward at lower ends of the two panels so that the magnets are seated on the catching portions, or the magnets pass over the catching portions by upward pressure.

In addition, the magnet pre-magnetization device may include: the index configured to simultaneously perform pre-magnetization processes for respective steps on the individual magnets while rotating the radially disposed holders by one pitch 1P to the first to fifth zones Z1 to Z5; a magnet supply part configured to continuously supply the non-magnetized magnets to the holder to predetermined sections; a magnetization coil part configured to magnetize the non-magnetized magnets, which are transferred by the holders, by a coil; a flux measurement part configured to measure flux of the pre-magnetized magnet transferred by the holder and transfer an inspection result (e.g., OK or NG) to the controller; a magnet loading part configured to load the pre-magnetized magnet, which is determined as being good (e.g., OK) by the inspection result, by pushing the pre-magnetized magnet with a loading finger when the pre-magnetized magnet reaches the magnet loading part, guide the pre-magnetized magnet to a designated magnet assembling position on the hub through a guide slot at a lower side, and tightly attach the pre-magnetized magnet; and a magnet unloading part configured to unload the pre-magnetized magnet, which is determined as being defective (e.g., NG) by the inspection result, to a collection box at a lower side by pushing the pre-magnetized magnet with an unloading finger when the pre-magnetized magnet reaches the magnet unloading part.

In addition, in the pre-magnetization process, two or more of a step of seating the non-magnetized magnet, which is supplied from the magnet supply part, on the holder positioned in the first zone Z1, a step of magnetizing the non-magnetized magnet, which is seated on the holder positioned in the second zone Z2, by means of the magnetization coil part, a step of inspecting the pre-magnetized magnet, which is seated on the holder positioned in the third zone Z3, by means of the flux measurement part, a step of loading the pre-magnetized magnet by means of the magnet loading part and preventing the loading of a defective (e.g., NG) magnet when a result of inspecting the pre-magnetized magnet seated on the holder positioned in the fourth zone Z4 indicates a good (e.g., OK) magnet, and a step of unloading the defective (NG) magnet by means of the magnet unloading part when the defective (e.g., NG) magnet is present on the holder positioned in the fifth zone Z5 may be simultaneously performed.

In addition, the magnet supply part may include: a first bowl feeder configured to supply magnets circumferentially oriented about the second axis C2 of the hub; a second bowl feeder configured to supply tangentially oriented magnets; and at least one third bowl feeder configured to supply diagonally oriented magnets.

In addition, the magnetization coil part may magnetize the magnets in accordance with the orientation directions of the non-magnetized magnets by changing a posture of the coil to various angles by means of a servo motor.

In addition, the magnetization coil part may change the magnets to a magnet magnetized in a circumferential direction, a magnet magnetized in a tangential direction, and a magnet magnetized in a diagonal direction by changing a rotation angle of the coil in accordance with the orientation direction.

In addition, the clamping jig device may include: the arrangement jig assembled with an iron ring interposed between a first circular plate and a second circular plate on which a plurality of clamping holes h are arranged in a circular shape based on a central axis; a second motor configured to rotate the arrangement jig coupled to a second axis by one pitch 1P; and the magnet clamping units installed to respectively correspond to the individual clamping holes h formed in a lateral surface of the arrangement jig and configured to clamp the loaded magnet while being moved forward by a cylinder.

In addition, the iron ring may have an outer diameter portion to which the hub is coupled, and the iron ring may be made of an iron (Fe) material that is a magnetic element and configured to generate a pulling force by a magnetic force of the magnet tightly attached to the hub.

In addition, the magnet clamping unit may be mounted on a lateral surface of the arrangement jig by means of a bracket, fix the magnet in a state in which a rectilinear pusher connected by a link structure penetrates a clamping hole h when a lever is moved forward by the cylinder, and be kept in a fixed state when the cylinder moves rearward.

In addition, the arrangement jig may be manufactured such that the total number of clamping holes is equal to the total number of magnets assembled to the hub.

In addition, in the arrangement jig, the first clamping hole h1 in the first circular plate and the second clamping hole h2 in the second circular plate may be formed to intersect each other, and the magnet clamping units, which respectively correspond to the holes h1 and h2 of the first circular plate and the second circular plate, may be mounted, while intersecting each other, at upper and lower sides.

Meanwhile, according to another aspect of the present disclosure, a method of manufacturing a Halbach array rotor includes: coupling a hub to an arrangement jig having a pulley shape and provided in a clamping jig device; supplying non-magnetized magnets to holders radially disposed on an index by using a magnet supply part provided in a magnet pre-magnetization device; performing a pre-magnetization process on the individual magnets by rotating the index by one pitch about a first axis C1 when the non-magnetized magnets are seated on the holders; loading the magnetized magnets to the hub coupled to the circular arrangement jig by means of the pre-magnetization process; fixing the individual magnets tightly attached to an outer peripheral surface of the hub by moving corresponding magnet clamping units forward; and rotating the arrangement jig by one pitch about a second axis C2 and determining that all the magnets are assembled when the counted number of pitches is equal to the total number of times of the pitch rotations of the hub.

The performing of the pre-magnetization process may include simultaneously performing: individually magnetizing the non-magnetized magnet seated on the holder positioned in a second zone Z2 by means of a magnetization coil part; inspecting the magnetized magnet on the holder positioned in a third zone Z3 by means of a flux measurement part; and identifying a result of inspecting the magnet on the holder positioned in a fourth zone Z4 and loading the magnet to a magnet assembling process by means of a magnet loading part when the magnet is determined as being good (e.g., OK).

In addition, the individual pre-magnetization process may further include preventing the loading of the magnet when the magnet is determined as being defective (e.g., NG) by the inspection result and unloading the magnet by means of a magnet unloading part when a defective (NG) magnet is present on the holder positioned in a fifth zone Z5.

In addition, the loading of the magnet to the magnet assembling process may include loading the magnetized magnet in accordance with a sequence of any one of eight-segment, six-segment, and four-segment Halbach arrays on the basis of design information on a rotor.

In addition, the method may further include: after the determining that all the magnets are assembled, maintaining the clamping of all the magnets assembled to the hub immediately until a covering process of fixing a cover to an outer diameter portion of the magnet.

According to the embodiment of the present disclosure, the pre-magnetization device, which individually magnetizes the non-magnetized magnet in accordance with the orientation, and the clamping jig device, which individually fixes the magnetized magnets after guiding the loading of the magnets onto to the hub, are operated in conjunction with each other, it is possible to overcome the assembling difficulty caused by the repulsive force between the magnets and automate the process of manufacturing the Halbach array rotor.

In addition, because the pre-magnetization assembling process, which has been manually performed in the related art, is automated, it is possible to improve the uniform performance and quality of the Halbach array rotor.

In addition, the clamped state of the magnets assembled to the hub is maintained before the process of covering the outer diameter portion, such that it is possible to reduce the number of processes, time, and costs by excluding the separate bonding process and the bonding material in the related art.

### BRIEF DESCRIPTION OF THE DRAWINGS

FIGS. 1 and 2 are a perspective view and a top plan view illustrating a configuration of a system for manufacturing a Halbach array rotor according to an embodiment of the present disclosure.

FIGS. 3 and 4 are views illustrating a configuration of a holder according to the embodiment of the present disclosure and illustrating a state in which magnets are seated and loaded.

FIGS. 5 and 6 are views illustrating states in which magnetization directions are variously changed in accordance with orientation directions of the supplied magnets according to the embodiment of the present disclosure.

FIG. 7 is a view illustrating a state in which magnets are loaded onto the hub coupled to the arrangement jig according to the embodiment of the present disclosure.

FIG. 8 is a view illustrating a state in which a defective magnet according to the embodiment of the present disclosure is unloaded.

FIG. 9 is an exploded view illustrating a hub coupling structure of an arrangement jig according to the embodiment of the present disclosure.

FIG. 10 is a view illustrating a configuration of a clamping jig device according to the embodiment of the present disclosure, and FIG. 11 is a view illustrating a clamping process flow of a magnet clamping unit during a process of loading the magnet.

FIG. 12 is a flowchart illustrating a method of manufacturing a Halbach array rotor according to the embodiment of the present disclosure.

FIG. 13 is a view illustrating a process of covering an outer diameter portion of the magnet assembled to a hub according to the embodiment of the present disclosure.

### DETAILED DESCRIPTION OF ILLUSTRATIVE EMBODIMENTS

Hereinafter, various embodiments of the present disclosure will be described in detail with reference to the accompanying drawings so that those skilled in the technical field to which the present disclosure pertains may practice the invention.

The terms used herein are merely for the purpose of describing a specific embodiment, and not intended to limit the present disclosure. The singular expressions used herein are intended to include the plural expressions unless the context clearly dictates otherwise. It is to be understood that the term “comprise (include)” and/or “comprising (including)” used in the present specification means that the features, the integers, the steps, the operations, the constituent elements, and/or component are present, but the presence or addition of one or more of other features, integers, steps, operations, constituent elements, components, and/or groups thereof is not excluded. The term “and/or” used herein includes any one or all the combinations of listed related items.

Throughout the specification, the terms such as “first,” “second,” “A,” “B,” “(a),” “(b),” and other numerical terms may be used herein only to describe various elements, but these elements should not be limited by these terms. These terms are used only for the purpose of discriminating one constituent element from another constituent element, and the nature, the sequences, or the orders of the constituent elements are not limited by the terms.

Throughout the specification, when one constituent element is described as being “connected” or “coupled” to another constituent element, it should be understood that one constituent element can be connected or coupled directly to another constituent element, and an intervening constituent element can also be present between the constituent elements. When one constituent element is described as being “connected directly to” or “coupled directly to” another constituent element, it should be understood that no intervening constituent element is present between the constituent elements.

Throughout the specification, the terms used herein are used for the purpose of describing particular embodiments only and are not intended to limit the present disclosure. Singular expressions include plural expressions unless clearly described as different meanings in the context.

In addition, it is understood that one or more of the following methods or aspects thereof may be carried out by at least one controller. The term “controller” may refer to a hardware device including a memory and a processor. The memory is configured to store program instructions, and the processor is specially programmed to execute the program instructions to perform one or more processes described below in more detail. The controller may control operations of units, modules, components, devices, or the like, as described herein. In addition, it is understood that the following methods may be carried out by an apparatus including the controller as well as one or more other components, as recognized by those skilled in the art.

Throughout the specification, a magnet, which is not magnetized, is referred to as a non-magnetized magnet, and a magnet, which is not separately named, is understood as a pre-magnetized/magnetized magnet.

Hereinafter, a system and method for manufacturing a Halbach array rotor according to an embodiment of the present disclosure will be described in detail with reference to the drawings.

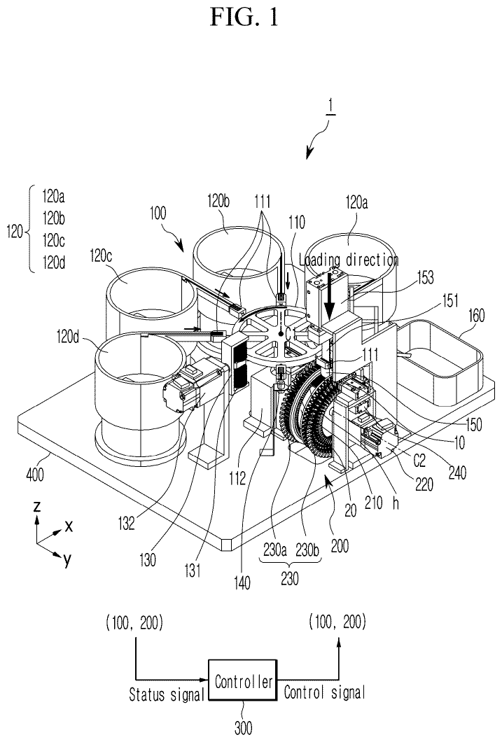

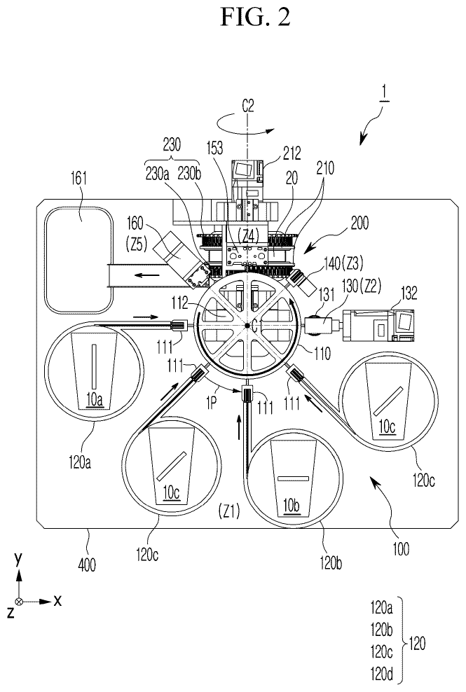

FIGS. 1 and 2 are a perspective view and a top plan view illustrating a configuration of the system for manufacturing a Halbach array rotor according to the embodiment of the present disclosure.

With reference to FIGS. 1 and 2, a system 1 for manufacturing a Halbach array rotor according to the embodiment of the present disclosure includes a magnet pre-magnetization device 100, a clamping jig device 200, a controller 300, and a base 400.

The magnet pre-magnetization device 100 seats non-magnetized magnets 10 on holders 111 radially disposed on an index 110, pre-magnetizes individual magnets 10 by using automation devices 120, 130, 140, 150, and 160 installed for respective rotation sections (e.g., zones Z1, Z2, Z3, Z4, and Z5) in one side rotation direction (e.g., a counterclockwise direction), and then loads the magnets 10 to an assembling process.

The clamping jig device 200 couples a hub 20 to a circular arrangement jig 210. The clamping jig device 200 is structured to fix the individual magnets 10, which are loaded to the assembling process and assembled along an outer peripheral surface of the hub 20, by means of individual magnet clamping units 230. The hub 20 is also called a rotor hub and has a ring structure. That is, when the magnetized magnets 10 are loaded from the magnet pre-magnetization device 100 and seated on the outer diameter portion of the hub 20, the clamping jig device 200 may fix positions of the magnets by operating the individual magnet clamping units 230.

The controller 300 magnetizes the non-magnetized magnet 10 in accordance with the orientation by collectively controlling the magnet pre-magnetization device 100 and the clamping jig device 200 and then assembles the magnetized magnet 10 to the hub 20 in accordance with a magnetization direction of the Halbach array.

The magnet pre-magnetization device 100 and the clamping jig device 200 are installed on an upper surface of the base 400.

The arrangement jig 210 is installed on the base 400 based on a loading direction of the magnet 10, and the arrangement jig 210 rotates about a second axis C2 orthogonal to a first axis C1 about which the index 110 rotates.

The index 110 and the arrangement jig 210 rotate by preset one pitch 1P to perform the pre-magnetization process and the assembling process on the individual magnets 10.

A rotation angle of one pitch P1 of the index 110 is determined (set) depending on the number of holders 111 radially disposed about the first axis C1. For example, eight holders 111 may be disposed on the index 110. When the index 110 rotates by a total of eight pitches, the index 110 rotates by one turn (360 degrees).

Likewise, the rotation angle of one pitch P1 of the arrangement jig 210 may be determined depending on the total number of magnets 10 assembled to (disposed on) the hub 20. For example, 200 to 300 magnets 10 may be assembled to the hub 20. Further, when the index rotates by all pitches corresponding to the number of magnets 10 installed on the hub 20, the index rotates by one turn (360 degrees), and all the magnets are completely assembled.

The remaining components of the system 1 for manufacturing a Halbach array rotor, which exclude some components positioned at the positions at which the magnets 10 are assembled during the assembling process, are made of nonferrous materials. This is to minimize interference occurring between the magnet 10, which is assembled after the pre-magnetization process, and the magnet 10, which is disposed in advance, by a repulsive force/attractive force.

The magnet pre-magnetization device 100 includes the index 110, a magnet supply part 120, a magnetization coil part 130, a flux measurement part 140, a magnet loading part 150, and a magnet unloading part 160.

The index 110 transfers the individual magnets 10, which are mounted on the holders 111 disposed radially, in a first direction (e.g., a counterclockwise direction), performs the pre-magnetization process, and loads the individual magnets 10 to the subsequent assembling process.

The index 110 may be rotated about a first rotation axis C1 by a first motor 112.

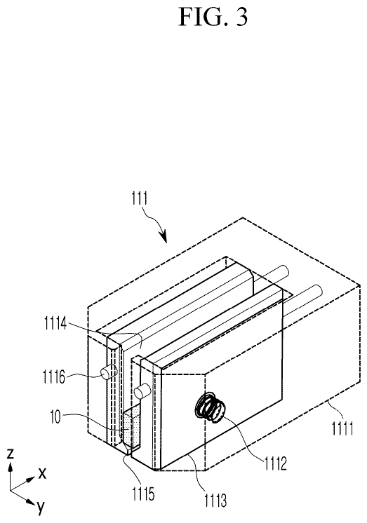

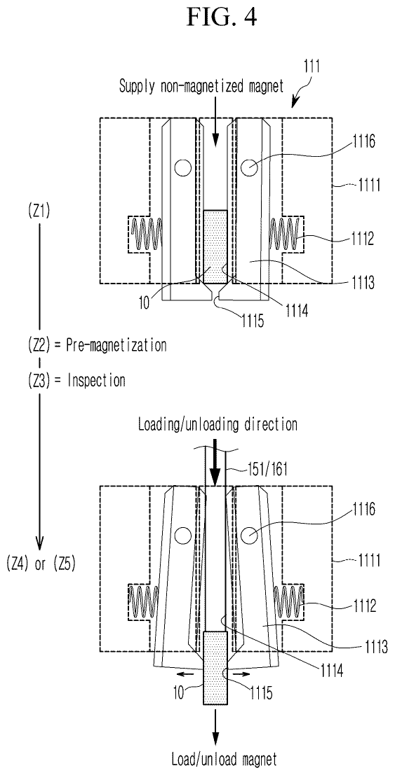

FIGS. 3 and 4 illustrate a configuration of the holder according to the embodiment of the present disclosure and illustrate a state in which the magnets are seated and loaded.

With reference to FIGS. 3 and 4, in the holder 111 according to the embodiment of the present disclosure, two panels 1113, which define a seating groove 1114 inside a housing 1111 having a “ [symbol] ”-shaped cross-section, are movably coupled by springs 1112 and hinges 1116. Catching portions 1115 are formed at lower ends of two opposite sides of the two panels 1113, such that the magnet 10 is seated on the catching portions 1115, and the magnet 10 may pass over the catching portions 1115 by upward pressure.

In this case, the index 110 according to the embodiment of the present disclosure performs the pre-magnetization process for respective steps on the individual magnets 10 by rotating the holders 111, which are disposed radially, by one pitch 1P to first to fifth zones Z1 to Z5.

For example, the pre-magnetization process, which performs the rotation by one pitch 1P, is characterized in that two or more of a step of seating the non-magnetized magnet 10, which is supplied from the magnet supply part 120, on the holder 111 positioned in the first zone Z1, a step of magnetizing the non-magnetized magnet 10, which is seated on the holder 111 positioned in the second zone Z2, by means of the magnetization coil part 130, a step of inspecting the pre-magnetized magnet 10, which is seated on the holder 111 positioned in the third zone Z3, by means of the flux measurement part 140, a step of loading the pre-magnetized magnet 10 by means of the magnet loading part 150 and preventing the loading of a defective (NG) magnet when a result of inspecting the pre-magnetized magnet 10 seated on the holder 111 positioned in the fourth zone Z4 indicates a good (OK) magnet, and a step of unloading the defective (NG) magnet 10 by means of the magnet unloading part 160 when the defective (NG) magnet 10 is present on the holder 111 positioned in the fifth zone Z5 are simultaneously performed.

The magnet supply part 120 is positioned in the first zone Z1 corresponding to a magnet supply process in the rotation section of the index 110.

The magnet supply part 120 continuously supplies the non-magnetized magnets 10 to the holder 111 to a predetermined section.

The magnet supply part 120 includes a plurality of bowl feeders installed in the orientation directions of the non-magnetized magnets 10.

For example, the magnet supply part 120 may include a total of four bowl feeders including a first bowl feeder 120a configured to supply magnets 10a circumferentially oriented about the second axis C2 of the hub 20, a second bowl feeder 120b configured to supply tangentially oriented magnets 10b, and two third bowl feeders 120c configured to supply diagonally oriented magnets 10c. The reason why the plurality of bowl feeders are used as described above is that the assembling magnets 10 are identical in shape but different in orientations/properties. However, the embodiment of the present disclosure is not limited thereto. The number of bowl feeders may be changed depending on the types of orientations of the magnets applied to the eight-segment, six-segment, and four-segment Halbach arrays.

The magnetization coil part 130 is positioned in the second zone Z2 corresponding to the pre-magnetization process in the rotation sections of the holders 111 of the index 110.

The magnetization coil part 130 may serve to magnetize the non-magnetized magnet 10, which is loaded by means of the index 110, by means of a coil 131.

Hereinafter, the magnet having passed over the magnetization coil part 130 means a pre-magnetization/magnetized magnet unless otherwise described.

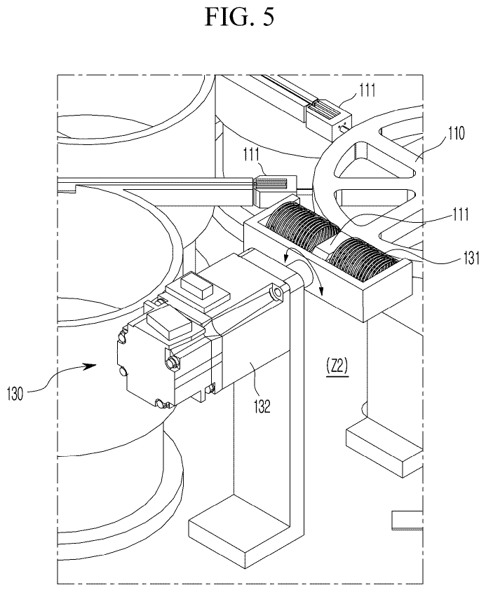

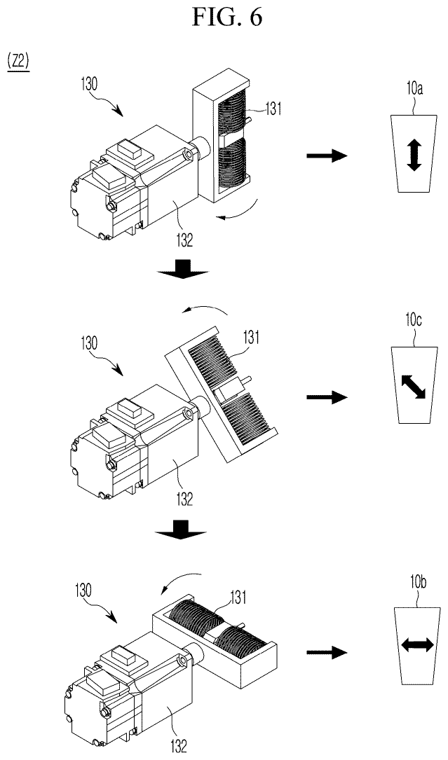

FIGS. 5 and 6 illustrate states in which magnetization directions are variously changed in accordance with orientation directions of the supplied magnets according to the embodiment of the present disclosure.

With reference to FIGS. 5 and 6, the magnetization coil part 130 according to the embodiment of the present disclosure may change a posture the coil 131 at various angles by means of a servo motor 132. Therefore, the magnetization coil part 130 may magnetize the magnets in accordance with the orientation directions of the non-magnetized magnets 10.

For example, the magnetization coil part 130 may change the magnetized magnet 10a in the circumferential direction (↑⊆), change the magnetized magnet 10b in the tangential direction (←→), and change the magnetized magnet 10c in the diagonal direction ( [symbol] ) by changing the rotation angle of the coil 131 (e.g., 0 degrees, 45 degrees, and 90 degrees) in accordance with three types of orientation directions (a, b, c).

In addition, in addition to 0 degrees, 45 degrees, and 90 degrees, all angles usable for the Halbach array may be applied. The magnetization coil part 130 avoids interference by changing the coil 131 to a 90-degree state when the index 110 rotates (see FIG. 5).

As described above, the magnets 10a, 10b, and 10c magnetized in various orientation directions may be assembled to the hub 20 in the Halbach array sequence under the control of the controller 300 during the subsequent magnet assembling process.

The flux measurement part 140 may be positioned in the third zone Z3 corresponding to a magnet inspection process in the rotation sections of the holders 111 of the index 110.

The flux measurement part 140 measures flux (magnetic flux) of the magnetized magnet 10, determines an inspection result (e.g., OK/NG), and/or transfers the inspection result to the controller 300.

For example, the inspection result (e.g., OK/NG) may indicate the good (e.g., OK) magnet when the flux of the magnetized magnet 10 is a reference value or more, and the inspection result (e.g., OK/NG) may indicate the defective (e.g., NG) magnet when the flux of the magnetized magnet 10 is less than the reference value.

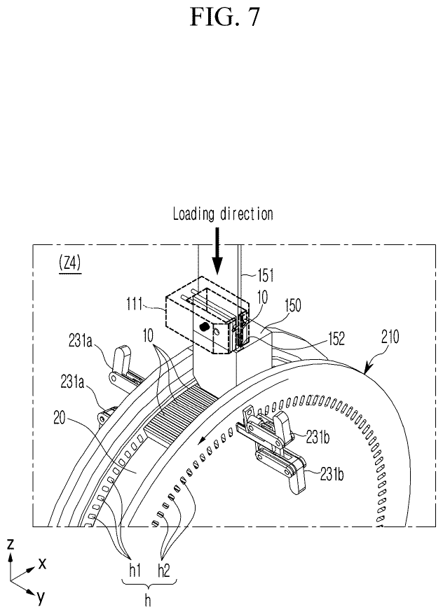

FIG. 7 illustrates a state in which the magnets are loaded onto the hub coupled to the arrangement jig according to the embodiment of the present disclosure by means of the magnet loading part.

With reference to FIG. 7, the magnet loading part 150 is positioned in the fourth zone Z4 consistent with the magnet loading direction in the rotation sections of the holders 111 of the index 110.

The magnet loading part 150 serves to load the magnetized magnet 10 in the holder 111 in the downward direction by pushing the magnetized magnet 10 with a loading finger 151, guide the magnet to a designated magnet assembling position on the hub 20 through a guide slot 152, and then tightly attach the magnet. In this case, the magnet loading part 150 may guide and insert the magnet while maintaining a predetermined gap g between the assembled magnets through the guide slot 152. For example, the gap g may be set to about 0.05 to 0.1 mm (see FIG. 11).

The magnet loading part 150 loads only the magnet 10 determined as being good (e.g., OK) by the inspection result in response to a control signal. That is, the magnet loading part 150 may prevent the loading of the magnet 10 determined as being defective (NG) and transfer the defective magnet to the magnet unloading part 160.

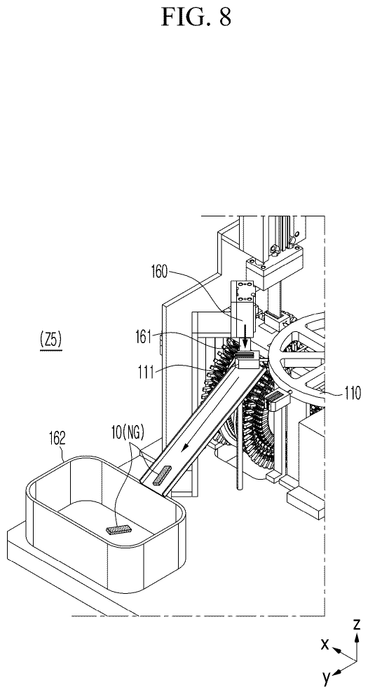

FIG. 8 illustrates a state in which a defective magnet according to the embodiment of the present disclosure is unloaded.

With reference to FIG. 8, the magnet unloading part 160 according to the embodiment of the present disclosure is positioned in the fifth zone Z5 in the rotation sections of the holders 111 of the index 110.

When the magnet 10, which is determined as being defective (e.g., NG) by the inspection result, reaches the magnet unloading part 160, the magnet unloading part 160 may unload the defective magnet to a collection box 162 at a lower side by pushing the magnet with an unloading finger 161.

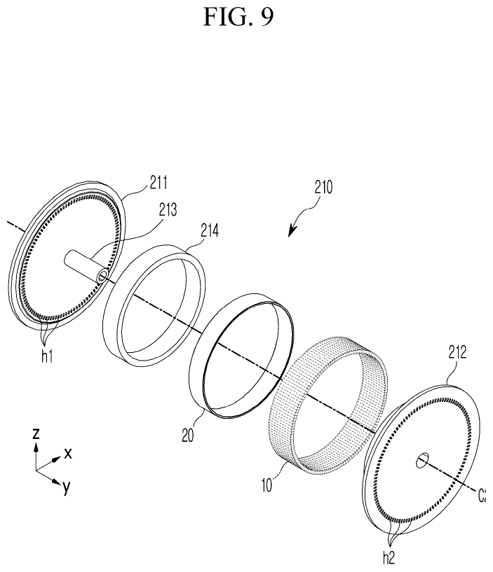

Meanwhile, the clamping jig device 200 will be specifically described with reference to FIGS. 9 to 11.

FIG. 9 is an exploded view illustrating a hub coupling structure of the arrangement jig according to the embodiment of the present disclosure.

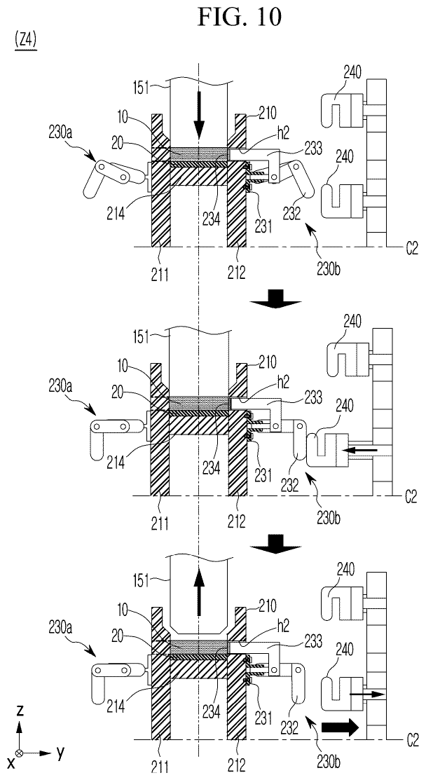

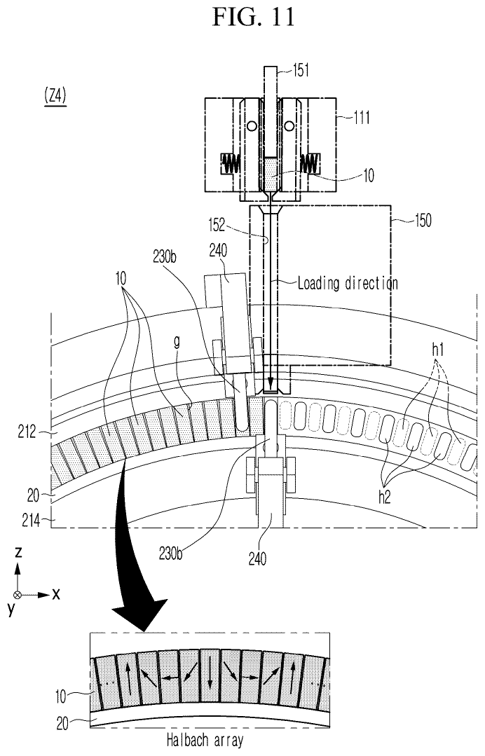

FIG. 10 illustrates a configuration of the clamping jig device according to the embodiment of the present disclosure, and FIG. 11 illustrates a clamping process flow of the magnet clamping unit during a process of loading the magnet.

With reference to FIGS. 9 to 11, the clamping jig device 200 according to the embodiment of the present disclosure includes the arrangement jig 210, a second motor 220, a magnet clamping unit 230, and a cylinder 240.

The arrangement jig 210 is assembled with an iron ring 214 interposed between a first circular plate 211 and a second circular plate 212 in which a plurality of clamping holes (h=h1+h2) are arranged in a circular shape based on a central axis 213.

In this case, the hub 20 is coupled to the outer diameter portion of the iron ring 214, and the iron ring 214 is made of an iron (Fe) material that is a magnetic element.

Therefore, in a state in which the magnet 10 is tightly attached to the magnet assembling position on the hub 20, the iron ring 214 generates a pulling force by a magnetic force of the magnet 10, thereby increasing a fixing force (assembling force) toward the inside (inner diameter).

The second motor 220 rotates, by one pitch 1P, the arrangement jig 210 coupled to the second axis C2.

The total number of clamping holes (h=h1+h2) formed in the arrangement jig 210 is equal to the total number of magnets assembled to the hub 20 (i.e., the total number of times of the pitch rotations required for the rotation of 360 degrees).

The magnet clamping units 230 are installed to respective correspond to individual clamping holes h formed in a lateral surface of the arrangement jig 210 and clamp the loaded individual magnets 10 by being operated by a forward movement of the cylinder 240.

The magnet clamping unit 230 is mounted by means of a bracket 231. When a lever 232 moves forward, a rectilinear pusher 233 connected by a link structure fixes the corresponding magnet 10 in a state in which the rectilinear pusher 233 penetrates the corresponding clamping hole h. In this case, the corresponding magnet 10 refers to the individual magnet corresponding to the magnet clamping unit 230 and the hole h.

The pusher 233 is mounted in a state in which the pusher 233 penetrates the corresponding clamping the hole h. When the pusher 233 moves forward/rearward, the pusher 233 may stroke at a predetermined interval (about 0.5 mm).

An elastic pad 234 is attached to an end of the pusher 233 and prevents an excessive load from being applied when the corresponding magnet 10 is clamped. The elastic pad 234 may be made of a material such as silicone or rubber.

Meanwhile, because the number of clamping holes h formed in the arrangement jig 210 is determined depending on the total number of the magnets 10, a space of the arrangement jig 210 for installing the magnet clamping units 230 for the respective individual clamping holes h is insufficient. For example, in case that small magnets with a width of 1.5 mm or less are disposed in the Halbach array with fifty-six polarities or more, it is difficult to install the individual magnet clamping units 230.

Therefore, in the present disclosure, a first clamping hole h1 is formed in the first circular plate 211 of the arrangement jig 210, a second clamping hole h2 is formed in the second circular plate 212, and the two holes h1 and h2 are formed at different positions while intersecting each other.

In addition, the magnet clamping units 230, which respectively correspond to the first clamping hole h1 and the second clamping hole h2, are mounted, while intersecting each other, at upper and lower sides on the outer surface of the first circular plate 211 and the outer surface of the second circular plate 212.

Therefore, the individual magnet clamping units 230, which correspond to the magnets 10 sequentially arranged on the hub 20, may be alternately installed above and below the first circular plate 211 of the arrangement jig 210 and the two holes h1 and h2 formed in the first circular plate 211.

Meanwhile, a magnet clamping process flow performed by the clamping jig device 200 at the time of loading the magnets will be described with reference to FIG. 11.

The magnet clamping process of the clamping jig device 200 associated with the magnet pre-magnetization device 100 of the present disclosure is performed in a one-pitch unit of the arrangement jig 210.

First, when the magnets are loaded from the magnet pre-magnetization device 100, the loading finger 151 moves downward and tightly attaches the magnet 10 to a magnet loading position on the hub 20. In this case, a fixing force of the magnet 10 is increased by a pulling force of the iron ring 214 disposed below the hub 20.

Next, the magnet clamping unit 230 fixes the corresponding magnet 10 by being operated as the lever 232 is operated forward by the cylinder 240 fixedly installed at the rear side. The cylinder 240 is installed at a position orthogonal to the magnet loading direction and serves to fix the corresponding magnet 10 by pushing the lever 232 while moving forward.

Next, when the corresponding magnet 10 is completely fixed, the cylinder 240 moves rearward and returns to an original position. In this case, the magnet clamping unit 230 may maintain the fixed state of the corresponding magnet 10 by the link structure even though the cylinder 240 is moved rearward in the state in which the lever 232 is moved forward.

Meanwhile, the controller 300 controls an overall operation of performing the method of manufacturing a Halbach array rotor based on the magnet pre-magnetization device 100 and the clamping jig device 200 according to the embodiment of the present disclosure.

The controller 300 provides unique identification information ID to the holders 111 radially disposed on the index 110. Further, the controller 300 may monitor the magnetization result (e.g., OK/NG) and the positions of the individual magnets 10 in the holders 111 for each pitch rotation of the index 110 and control whether to load Z4/unload Z5 the magnet on the basis of the result.

For example, in case that a magnetization defect (e.g., NG) signal is inputted from the flux measurement part 140, the controller 300 recognizes a magnet holder ID positioned in the current magnetization inspection zone Z3. Further, the controller may perform control so that the magnet is not loaded (is prevented from being loaded) even though the magnet holder ID is positioned in the magnet loading position, and the magnet is unloaded when the magnet holder ID is positioned on the magnet unloading part 160.

The automation is implemented so that the pre-magnetization process and the subsequent magnet assembling process are performed in conjunction with each other, such that it is possible to reduce the number of processes, time, and costs required to magnetize the individual magnets in the related art. This effect may provide a further improved effect because the assembling difficulty increases as the number of Halbach array rotor magnets assembled to the rotor increases.

Meanwhile, the method of manufacturing a Halbach array rotor of the present disclosure, which may be carried out by the configuration of the above-mentioned system 1 for manufacturing a Halbach array rotor, will be described.

The method of manufacturing a Halbach array rotor according to the embodiment of the present disclosure may be automatically controlled by the controller 300 configured to control the overall operation of the system 1 for manufacturing a Halbach array rotor.

The controller may be implemented as one or more processors operated by a set program (e.g., including instructions stored in one or more memory devices), in which the set program is programmed to perform each step of the method of manufacturing a Halbach array rotor according to the embodiment of the present disclosure.

Hereinafter, the method of manufacturing a Halbach array rotor will be specifically described with reference to the following drawings.

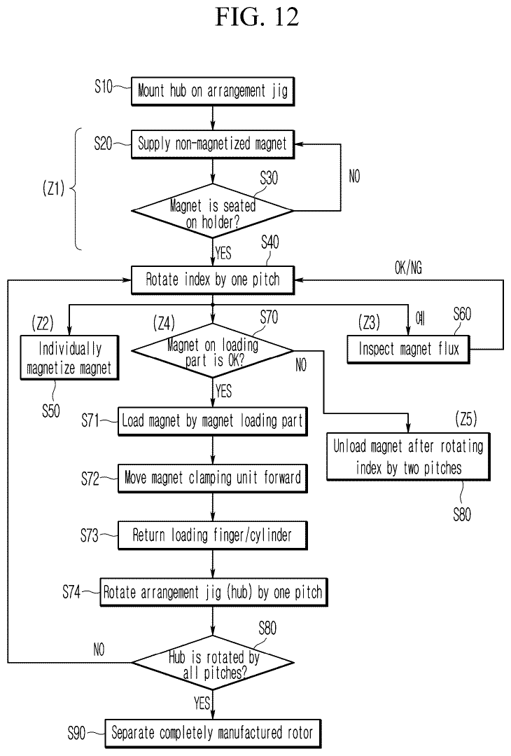

FIG. 12 is a flowchart illustrating the method of manufacturing a Halbach array rotor according to the embodiment of the present disclosure.

With reference to FIG. 12, the method of manufacturing a Halbach array rotor according to the embodiment of the present disclosure starts with mounting the hub 20 on the arrangement jig 210 having a pulley shape and provided in the clamping jig device 200 (S10).

The controller 300 supplies the non-magnetized magnets 10 to the holders 111 radially disposed on the index 110 of the magnet pre-magnetization device 100 by using the magnet supply part 120 installed in the first zone Z1 (S20).

The controller 300 checks whether the magnet 10 is seated on the holder 111 (S30).

In this case, when the magnet 10 fails to be seated on the holder 111 (S30; NO), the controller 300 may continue to supply the non-magnetized magnet 10 by means of the magnet supply part 120 (S20).

In contrast, when the magnet 10 succeeds in being seated on the holder 111 (S30; YES), the controller 300 rotates the index 110 by one pitch about the first axis C1 and performs the pre-magnetization process on the individual magnets 10 by means of the automation device for the respective rotation zones (40).

In this case, the pre-magnetization process is characterized in that a step S50 of individually magnetizing the non-magnetized magnet 10, which is seated on the holder 111 positioned in the second zone Z2, by means of the magnetization coil part 130, a step S60 of inspecting the magnetized magnet 10, which is seated on the holder 111 positioned in the third zone Z3, by means of the flux measurement part 140, and a step S71 of identifying a result of inspecting the magnet 10 on the holder 111 positioned in the fourth zone Z4 (S70) and loading the magnet to the magnet assembling process by means of the magnet loading part 150 when the magnet is determined as being good (e.g., OK) (S70; YES) are simultaneously performed.

In this case, the individual pre-magnetization process may further include a step of preventing the loading when the inspection result indicates that the magnet 10 is defective (e.g., NG) (S70; NO) and unloading the magnet by means of the magnet unloading part 160 when the defective (e.g., NG) magnet 10 is present on the holder 111 positioned in the fifth zone Z5.

In addition, in the step S50 of individually magnetizing the magnet, the controller 300 magnetizes the magnet in any one of the circumferential direction (a), the tangential direction (b), and the diagonal direction (c) by changing the angle of the coil 131 of the magnetization coil part 130 depending on the orientation direction of the non-magnetized magnet 10.

Hereinafter, in the flow, the magnet 10 refers to the magnetized magnet.

In the step S60 of inspecting the magnet, the controller 300 may measure the flux of the magnetized magnet 10 by means of the flux measurement part 140 and collect the inspection result (e.g., OK/NG) in accordance with whether the reference value is satisfied.

Meanwhile, the controller 300 loads the magnet 10, which is seated on the holder 111, in the downward direction by pushing the magnet with the loading finger 151 at the time of loading the magnet, guides the magnet to the desired magnet assembling position on the hub 20 through the guide slot 152, and then tightly attaches the magnet (S71).

In this case, the controller 300 may load the magnetized magnet 10 in accordance with the sequence of any one of the eight-segment, six-segment, and four-segment Halbach arrays on the basis of the design (manufacturing) information of a rotor 30.

The controller 300 moves the magnet clamping unit 230 forward by using the cylinder 240 and fixes the tightly attached magnet 10 to the arrangement jig 210 (S73).

When the magnet 10 is completely fixed, the controller 300 returns the loading finger 151 and the cylinder 240 to the original position (S73). In this case, the magnet clamping unit 230 may maintain the fixed state of the corresponding magnet 10 by the link structure even though the cylinder 240 returns to the original position.

The controller 300 rotates the arrangement jig 210 by one pitch about the second axis C2 and counts the number of pitches (S74).

The controller 300 identifies whether the counted number of pitches is equal to the total number of times of the pitches of the hub 10 (S80).

In this case, when the counted number of pitches is less than the total number of times of the pitch rotations of the hub 10 (S80; NO), the controller 300 returns to the step S40 and repeats the pre-magnetization process and the clamping process on the individual magnets 10.

Thereafter, when the counted number of pitches is equal to the total number of times of the pitch rotations of the hub 10 (S80; YES), the controller determines that all the magnets are assembled, and the controller separates the magnets from the arrangement jig 210. In this case, the Halbach array rotor is manufactured by covering the outer diameter portion of the magnet 10 of the hub 10 with a cover 30, and the rotor is separated from the arrangement jig 210 (S90). In this case, in case that the hub 20 rotates by all the pitches (e.g., 200 to 300 magnets), all the magnets are completely loaded. Therefore, the rotation of the index 110 may end, and the hub 10 may be unloaded.

In addition, the clamping on all the magnets 10 assembled to the hub 20 is maintained immediately until the covering process is performed on the outer diameter portion.

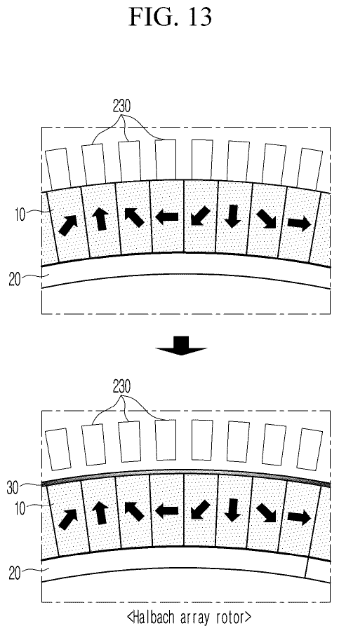

For example, FIG. 13 illustrates a process of covering an outer diameter portion of the magnet assembled to the hub according to the embodiment of the present disclosure.

With reference to FIG. 13, all the magnets 10 assembled to the hub 20 are kept clamped by the individual magnet clamping units 230.

Further, the outer diameter portions of all the magnets 10 assembled to the hub 20 may be fixed to the cover 30, and the clamping of the magnet clamping unit 230 may be released.

The cover 30 may fix all the magnets 10 by covering (winding) the outer diameter portion with a mixture of carbon fiber resin plastic (CFRP) and resin.

Therefore, it is possible to exclude (eliminate) a separate bonding material and a bonding process for assembling the pre-magnetized magnet to the hub or fixing the assembled magnet before the covering process during the process of manufacturing the rotor in the related art. Therefore, it is possible to reduce the bonding material costs and the process time by excluding the separate bonding process.

As described above, according to the embodiment of the present disclosure, the pre-magnetization device, which individually magnetizes the non-magnetized magnet in accordance with the orientation, and the clamping jig device, which individually fixes the magnetized magnets after guiding the loading of the magnets onto to the hub, are operated in conjunction with each other, it is possible to overcome the assembling difficulty caused by the repulsive force between the magnets and automate the process of manufacturing the Halbach array rotor.

In addition, because the pre-magnetization assembling process, which has been manually performed in the related art, is automated, it is possible to improve the uniform performance and quality of the Halbach array rotor.

In addition, the clamped state of the magnets assembled to the hub is maintained before the process of covering the outer diameter portion, such that it is possible to reduce the number of processes, time, and costs by excluding the separate bonding process and the bonding material in the related art.

The exemplary embodiments of the present disclosure are not implemented only by the apparatus and/or method described above. Based on the above-mentioned descriptions of the exemplary embodiments, those skilled in the art to which the present disclosure pertains may easily realize the exemplary embodiments through programs for realizing functions corresponding to the configuration of the exemplary embodiment of the present disclosure or recording media on which the programs are recorded.

Although the embodiments of the present disclosure have been described in detail above, the right scope of the present disclosure is not limited thereto, and it should be construed that many variations and modifications made by those skilled in the art using the basic concept of the present disclosure, which is defined in the following claims, will also belong to the right scope of the present disclosure.

### DESCRIPTION OF SYMBOLS

1: System for manufacturing Halbach array rotor,
10: Magnet,
20: Hub,
30: Cover,
100: Magnet pre-magnetization device,
110: index,
111: Holder,
1111: Housing
1112: Spring,
1113: Panel,
1114: Seating groove,
1115: Catching portion,
1116: Hinge,
120: Magnet supply part,
130: Magnetization coil part,
131: Coil,
132: Servo motor,
140: Flux measurement part,
150: Magnet loading part,
151: Loading finger,
152: Guide slot,
160: Magnet unloading part,
161: Unloading finger,
162: Collection box,
200: Clamping jig device,
210: Arrangement jig,
211: First circular plate,
212: Second circular plate,
213: Central axis,
214: Iron ring,
220: Second motor,
230: Magnet clamping unit,
231: Bracket,
232: Lever,
233: Pusher,
234: Elastic pad,
240: Cylinder,
300: Controller,
400: Base,
Z1 to Z5: First to fifth zones

What is claimed is:

1. A system for manufacturing a Halbach array rotor, the system comprising:
a magnet pre-magnetization device configured to:
seat non-magnetized magnets on holders radially disposed on an index;
pre-magnetize the individual magnets by using automation devices installed for respective rotation sections in one side rotation direction; and
load the magnets to a hub;
a clamping jig device configured to:
couple the hub to a circular arrangement jig; and
fix the individual magnets loaded onto an outer peripheral surface of the hub using corresponding magnet clamping units; and
a controller, executing on one or more processors and configured to:
magnetize the non-magnetized magnets in accordance with orientations by collectively controlling the magnet pre-magnetization device and the clamping jig device; and
assemble the magnetized magnets on the hub in accordance with a magnetization direction of a Halbach array.

2. The system of claim 1, further comprising:
a base on which the circular arrangement jig, which rotates about a second axis C2 orthogonal to a first axis C1 about which the index rotates, is installed based on a loading direction of the magnet.

3. The system of claim 1, wherein:
the index and the circular arrangement jig rotate by a respective preset one pitch 1P to perform pre-magnetization and assembling processes corresponding to the individual magnets.

4. The system of claim 3, wherein:
a rotation angle of the preset one pitch P1 of the index is determined depending on a number of holders disposed radially, and
a rotation angle of the preset one pitch P1 of the circular arrangement jig is determined depending on a total number of magnets assembled to the hub.

5. The system of claim 1, wherein:
each holder of the holders has a structure in which two panels, which define a seating groove inside a housing having a “ [symbol] ”-shaped cross-section, are movably coupled by springs and hinges, and
catching portions are formed inward at lower ends of the two panels so that the magnets are seated on the catching portions, or the magnets pass over the catching portions by upward pressure.

6. The system of claim 1, wherein the magnet pre-magnetization device comprises:
the index configured to simultaneously perform pre-magnetization processes for respective steps on the individual magnets while rotating the radially disposed holders by one pitch 1P to first to fifth zones Z1 to Z5;
a magnet supply part configured to continuously supply the non-magnetized magnets to the holder to predetermined sections;
a magnetization coil part configured to magnetize the non-magnetized magnets, which are transferred by the holders, by a coil;
a flux measurement part configured to measure flux of the pre-magnetized magnet transferred by the holder and transfer an inspection result to the controller;
a magnet loading part configured to load the pre-magnetized magnet, which is determined as being good by the inspection result, by:
pushing the pre-magnetized magnet with a loading finger when the pre-magnetized magnet reaches the magnet loading part;
guide the pre-magnetized magnet to a designated magnet assembling position on the hub through a guide slot at a lower side; and
attach the pre-magnetized magnet; and
a magnet unloading part configured to unload the pre-magnetized magnet, which is determined as being defective by the inspection result, to a collection box at a lower side by pushing the pre-magnetized magnet with an unloading finger when the pre-magnetized magnet reaches the magnet unloading part.

7. The system of claim 6, wherein:
in the pre-magnetization process, two or more of a step of seating the non-magnetized magnet, which is supplied from the magnet supply part, on the holder positioned in the first zone Z1, a step of magnetizing the non-magnetized magnet, which is seated on the holder positioned in the second zone Z2, by using the magnetization coil part, a step of inspecting the pre-magnetized magnet, which is seated on the holder positioned in the third zone Z3, by using the flux measurement part, a step of loading the pre-magnetized magnet by using the magnet loading part and preventing the loading of a defective magnet when a result of inspecting the pre-magnetized magnet seated on the holder positioned in the fourth zone Z4 indicates a good (OK) magnet, and a step of unloading the defective magnet by using the magnet unloading part when the defective magnet is present on the holder positioned in the fifth zone Z5 are simultaneously performed.

8. The system of claim 6, wherein the magnet supply part comprises:
a first bowl feeder configured to supply magnets circumferentially oriented about a second axis C2 of the hub;
a second bowl feeder configured to supply tangentially oriented magnets; and
at least one third bowl feeder configured to supply diagonally oriented magnets.

9. The system of claim 6, wherein:
the magnetization coil part magnetizes the magnets in accordance with orientation directions of the non-magnetized magnets by changing a posture of the coil to various angles by using a servo motor.

10. The system of claim 9, wherein:
the magnetization coil part changes the magnets to a magnet magnetized in a circumferential direction, a magnet magnetized in a tangential direction, and a magnet magnetized in a diagonal direction by changing a rotation angle of the coil in accordance with the orientation directions.

11. The system of claim 1, wherein:
the clamping jig device comprises:
the circular arrangement jig assembled with an iron ring interposed between a first circular plate and a second circular plate on which a plurality of clamping holes h are arranged in a circular shape based on a central axis;
a second motor configured to rotate the circular arrangement jig coupled to a second axis by one pitch 1P; and
the magnet clamping units installed to respectively correspond to individual clamping holes h formed in a lateral surface of the circular arrangement jig and configured to clamp the loaded magnet while being moved forward by a cylinder.

12. The system of claim 11, wherein:
the iron ring has an outer diameter portion to which the hub is coupled, and the iron ring is made of an iron (Fe) material that is a magnetic element and configured to generate a pulling force by a magnetic force of the magnet tightly attached to the hub.

13. The system of claim 11, wherein:
the magnet clamping unit is mounted on a lateral surface of the circular arrangement jig by using a bracket, fixes the magnet in a state in which a rectilinear pusher connected by a link structure penetrates a clamping hole h when a lever is moved forward by the cylinder, and is kept in a fixed state when the cylinder moves rearward.

14. The system of claim 11, wherein:
the circular arrangement jig is manufactured such that a total number of clamping holes is equal to a total number of magnets assembled to the hub.

15. The system of claim 11, wherein:
in the circular arrangement jig, a first clamping hole h1 in the first circular plate and a second clamping hole h2 in the second circular plate are formed to intersect each other, and the magnet clamping units, which respectively correspond to the holes h1 and h2 of the first circular plate and the second circular plate, are mounted, while intersecting each other, at upper and lower sides.

16. A method of manufacturing a Halbach array rotor, the method comprising:
coupling a hub to an arrangement jig having a pulley shape and provided in a clamping jig device;
supplying non-magnetized magnets to holders radially disposed on an index by using a magnet supply part provided in a magnet pre-magnetization device;
performing a pre-magnetization process on the individual magnets by rotating the index by one pitch about a first axis C1 when the non-magnetized magnets are seated on the holders;
loading the magnetized magnets to the hub coupled to the arrangement jig by using the pre-magnetization process;
fixing the individual magnets tightly attached to an outer peripheral surface of the hub by moving corresponding magnet clamping units forward; and
rotating the arrangement jig by one pitch about a second axis C2 and determining that all the magnets are assembled when a counted number of pitches is equal to a total number of times of pitch rotations of the hub.

17. The method of claim 16, wherein the performing of the pre-magnetization process comprises simultaneously performing:
individually magnetizing the non-magnetized magnet seated on the holder positioned in a second zone Z2 by using a magnetization coil part;
inspecting the magnetized magnet on the holder positioned in a third zone Z3 by using a flux measurement part; and
identifying a result of inspecting the magnet on the holder positioned in a fourth zone Z4 and loading the magnet to a magnet assembling process by using a magnet loading part when the magnet is determined as being good.

18. The method of claim 17, wherein:
the individual pre-magnetization process further comprises preventing the loading of the magnet when the magnet is determined as being defective by an inspection result and unloading the magnet by using a magnet unloading part when a defective magnet is present on the holder positioned in a fifth zone Z5.

19. The method of claim 17, wherein:
the loading of the magnet to the magnet assembling process comprises loading the magnetized magnet in accordance with a sequence of any one of eight-segment, six-segment, and four-segment Halbach arrays on a basis of design information on a rotor.

20. The method of claim 16, further comprising:
after the determining that all the magnets are assembled, maintaining the clamping of all the magnets assembled to the hub immediately until a covering process of fixing a cover to an outer diameter portion of the magnet.
